(19) United States
(12) Patent Application Publication
(10) Pub. No.: US 2016/0190708 A1
(43) Pub. Date: Jun. 30, 2016

(54) Antenna device

(71) Applicant: Richard Smith, Dallas, TX (US)

(72) Inventor: Richard Smith, Dallas, TX (US)

(21) Appl. No.: 14/801,527

(22) Filed: Jul. 16, 2015

Related U.S. Application Data
(60) Provisional application No. 62/065,908, filed on Oct. 20, 2014.

(51) Int. Cl. H01Q 21/26; H01Q 1/24; H01Q 5/307

(52) U.S. Cl. CPC H01Q 21/26; H01Q 5/307; H01Q 1/241

(57) ABSTRACT

An antenna array for receiving and transmitting signals may include a printed circuit board, a first dual frequency band element for transmitting and receiving the signals being mounted on a first end of the printed circuit board and a second dual frequency band element for transmitting and receiving the signals being mounted on a second end of the printed circuit board.

### FIELD OF THE INVENTION

The present invention relates to an antenna device and more particularly to a dual band antenna.

### BACKGROUND

An antenna is an electrical device which converts electric power into radio waves, and vice versa. It is usually used with a radio transmitter or a radio receiver. In transmission, a radio transmitter supplies an electric current oscillating at radio frequency (i.e. high frequency AC) to the antenna's terminals, and the antenna radiates the energy from the current as electromagnetic waves (radio waves). In reception, an antenna intercepts some of the power of an electromagnetic wave in order to produce a tiny voltage at its terminals that is applied to a receiver to be amplified.

Antennas are essential components of all equipment that uses radio. They are used in systems such as radio broadcasting, broadcast television, two-way radio, communications receivers, radar, cell phones, and satellite communications, as well as other devices such as garage door openers, wireless microphones, bluetooth enabled devices, wireless computer networks, baby monitors, and RFID tags on merchandise.

Typically, an antenna consists of an arrangement of metallic conductors (elements), electrically connected (often through a transmission line) to the receiver or transmitter. An oscillating current of electrons forced through the antenna by a transmitter will create an oscillating magnetic field around the antenna elements, while the charge of the electrons also creates an oscillating electric field along the elements. These time-varying fields radiate away from the antenna into space as a moving transverse electromagnetic field wave. Conversely, during reception, the oscillating electric and magnetic fields of an incoming radio wave exert force on the electrons in the antenna elements, causing them to move back and forth, creating oscillating currents in the antenna.

Antennas may also include reflective or directive elements or surfaces not connected to the transmitter or receiver, such as parasitic elements, parabolic reflectors or horns, which serve to direct the radio waves into a beam or other desired radiation pattern. Antennas can be designed to transmit or receive radio waves in all directions equally (omnidirectional antennas), or transmit them in a beam in a particular direction, and receive from that one direction only (directional or high gain antennas).

A Balun is used to “balance” unbalanced systems—i.e. those where power flows from an unbalanced line to a balanced line (hence, balun derives from balance to unbalanced).

### SUMMARY

An antenna array for receiving and transmitting signals may include a printed circuit board, a first dual frequency band element for transmitting and receiving the signals being mounted on a first end of the printed circuit board and a second dual frequency band element for transmitting and receiving the signals being mounted on a second end of the printed circuit board.

The antenna array may include a first antenna and the first antenna is angled at a first angle with respect to the horizontal plane.

The antenna array may include a second antenna angled at a second angle beta.

The first dual frequency band element may include a first low frequency band element and a pair of first high frequency band element and the first low frequency band element may be between the pair of first high frequency band elements;

The second dual frequency band element may include a second low frequency band element and a pair of second high frequency band elements and wherein the second low frequency band element is between the pair of second high frequency band elements.

The first dual band elements may include a pair of first band element, and each first band element may be positioned longitudinally adjacent to the other first band element.

The second dual band elements may include a pair of second band element, and each second band dipole may be positioned longitudinally adjacent to the other second band element.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front view of the antenna of the present invention;

FIG. 2 illustrates a back perspective view of the antenna of the present invention;

FIG. 3 illustrates a back view of the antenna of the present invention;

FIG. 4 illustrates a side perspective view of the antenna of the present invention;

FIG. 5 illustrates a bottom view of the antenna of the present invention;

FIG. 6 illustrates a top view of the antenna of the present invention;

FIG. 7 illustrates another perspective view of the antenna of the present invention.

### DETAILED DESCRIPTION

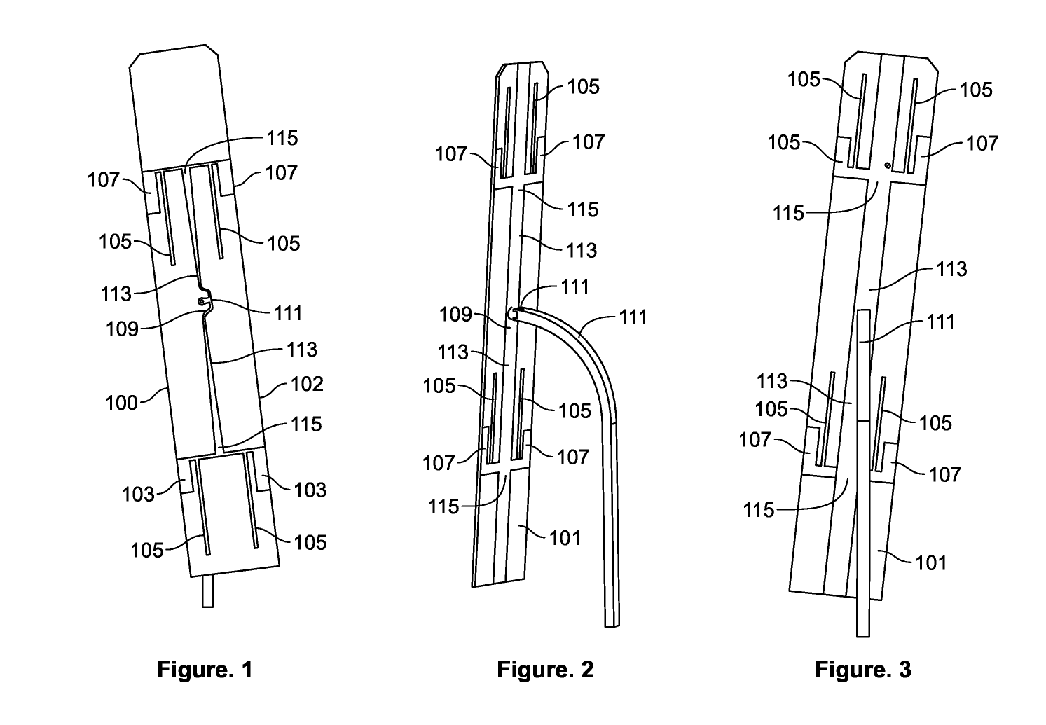

FIG. 1 illustrates a front view of the antenna 100 of the present invention. The antenna 100 may include a multitude of dual band elements for example a pair of opposing dual band elements which may be mounted on opposing ends of the longitudinal printed circuit board 102 and which may include a first dual band element 101 which may be positioned on a first end of the printed circuit board 102 and the second dual band element 103 which may be positioned on the second end of the printed circuit board 102. Each of the first dual band element 101 and the second dual band element 103 may include a pair of lower frequency band radiating elements 105 and a pair of higher frequency band radiating elements 107. The lower frequency band radiating elements 105 may include a pair of lower frequency band arms, and the higher frequency band radiating elements 107 may include a pair of high frequency band arms which may be positioned outside of the lower frequency band arms and may be of unequal length to assist in creating a omnidirectional antenna pattern in the azimuth plane. The lower frequency band arms may be of substantially equal length.

The lengths of the high frequency band arms of the first dual band element 101 may be mirrored in the second dual band element 103 with respect to the longitudinal axis of the printed circuit board PCB 102.

FIG. 1 additionally illustrates a feed terminal 109 which may be approximately equidistant from the first dual band element 101 and the second dual band element 103 and which may be positioned on the PCB 102. The feed terminal 109 may connect a feed coaxial cable 111 which may connect to the signal source for the antenna to a transmission line 113 and may extend to the first dual band element 101 and to the second dual band element 103 and which may be a 100 ohm microstrip transmission line. The center conductor of the coaxial cable 111 may connect to the dual band elements 101, 103 while the outer conductor of the coaxial cable 111 may connect to the ground of the printed circuit board 102. Each of the transmission lines 113 may terminate in an impedance transformer 115 which may connect to the first dual band element 101 and the second dual band element 103 to supply the signal from the signal source to the respective elements 101, 103. The impedance transformer 115 may be a tapered, wideband, impedance transformer.

FIG. 2 illustrates a perspective view of the antenna 100 of the present invention. The antenna 100 may include a multitude of dual band elements for example a pair of opposing dual band elements which may be mounted on opposing ends of the longitudinal printed circuit board 102 and which may include a first dual band element 101 which may be positioned on a first end of the printed circuit board 102 and the second dual band element 103 which may be positioned on the second end of the printed circuit board 102. Each of the first dual band element 101 and the second dual band element 103 may include a pair of lower frequency band radiating elements 105 and a pair of higher frequency band radiating elements 107. The lower frequency band radiating elements 105 may include a pair of lower frequency band arms, and the higher frequency band radiating elements 107 may include a pair of high frequency band arms which may be positioned outside of the lower frequency band arms and may be of unequal length to assist in creating a omnidirectional antenna pattern in the azimuth plane. The lower frequency band arms may be of substantially equal length.

The lengths of the high frequency band arms of the first dual band element 101 may be mirrored in the second dual band element 103 with respect to the longitudinal axis of the printed circuit board PCB 102.

FIG. 2 additionally illustrates a feed terminal 109 which may be approximately equidistant from the first dual band element 101 and the second dual band element 103 and which may be positioned on the PCB 102. The feed terminal 109 may connect a feed coaxial cable 111 which may connect to the signal source for the antenna to a transmission line 113 and may extend to the first dual band element 101 and to the second dual band element 103 and which may be a 100 ohm microstrip transmission line. The center conductor of the coaxial cable 111 may connect to the dual band elements 101, 103 while the outer conductor of the coaxial cable 111 may connect to the ground of the printed circuit board 102. Each of the transmission lines 113 may terminate in an impedance transformer 115 which may connect to the first dual band element 101 and the second dual band element 103 to supply the signal from the signal source to the respective elements 101, 103. The impedance transformer 115 may be a tapered, wideband, impedance transformer.

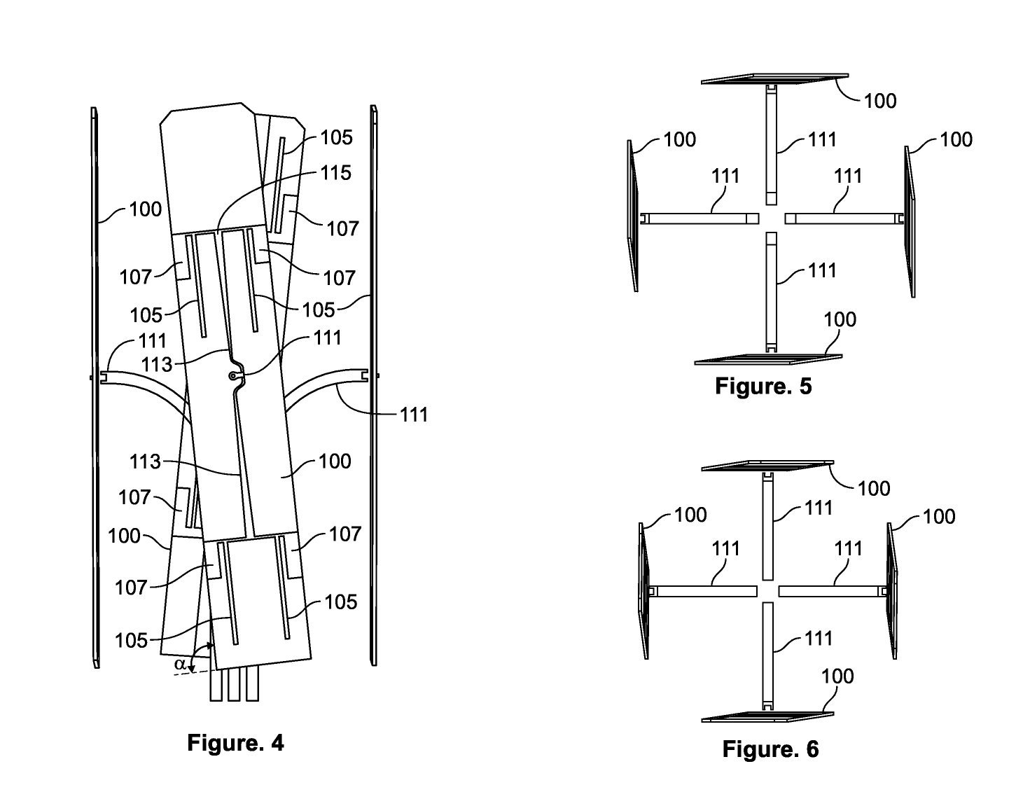

FIG. 3 illustrates a back/ground view of the antenna 100 of the present invention. The antenna 100 may include a multitude of dual band elements for example a pair of opposing dual band elements which may be mounted on opposing ends of the longitudinal printed circuit board 102 and which may include a first dual band element 101 which may be positioned on a first end of the printed circuit board 102 and the second dual band element 103 which may be positioned on the second end of the printed circuit board 102. Each of the first dual band element 101 and the second dual band element 103 may include a pair of lower frequency band radiating elements 105 and a pair of higher frequency band radiating elements 107. The lower frequency band radiating elements 105 may include a pair of lower frequency band arms, and the higher frequency band radiating elements 107 may include a pair of high frequency band arms which may be positioned outside of the lower frequency band arms and may be of unequal length to assist in creating a omnidirectional antenna pattern in the azimuth plane. The lower frequency band arms may be of substantially equal length.

The lengths of the high frequency band arms of the first dual band element 101 may be mirrored in the second dual band element 103 with respect to the longitudinal axis of the printed circuit board PCB 102.

FIG. 3 additionally illustrates a feed terminal 109 which may be approximately equidistant from the first dual band element 101 and the second dual band element 103 and which may be positioned on the PCB 102. The feed terminal 109 may connect a feed coaxial cable 111 which may connect to the signal source for the antenna to a transmission line 113 and may extend to the first dual band element 101 and to the second dual band element 103 and which may be a 100 ohm microstrip transmission line. The center conductor of the coaxial cable 111 may connect to the dual band elements 101, 103 while the outer conductor of the coaxial cable 111 may connect to the ground of the printed circuit board 102. Each of the transmission lines 113 may terminate in an impedance transformer 115 which may connect to the first dual band element 101 and the second dual band element 103 to supply the signal from the signal source to the respective elements 101, 103. The impedance transformer 115 may be a tapered, wideband, impedance transformer.

FIG. 4 illustrates a perspective/side view an array of the antennas 100 of the present invention. Each of the antennas 100 may be angled/inclined at an angle alpha a (between 0 and 90°) with respect to the horizontal by rotating the printed circuit board 102 with respect to the orientation of the coaxial to reduce the interaction of the lower and higher frequency bands of respective single antenna 100. Another antenna 100 may be angled at a different angle beta β and each antenna 100 may be angled at a different angle than any of the other antennas 100 The rotation of the antenna 100 reduces the interaction of other antenna 100 in the array and assists in radiating an omnidirectional antenna pattern. Each of the antennas 100 may include a multitude of dual band elements for example a pair of opposing dual band elements which may be mounted on opposing ends of the longitudinal printed circuit board 102 and which may include a first dual band element 101 which may be positioned on a first end of the printed circuit board 102 and the second dual band element 103 which may be positioned on the second end of the printed circuit board 102. Each of the first dual band element 101 and the second dual band element 103 may include a pair of lower frequency band radiating elements 105 and a pair of higher frequency band radiating elements 107. The lower frequency band radiating elements 105 may include a pair of lower frequency band arms, and the higher frequency band radiating elements 107 may include a pair of high frequency band arms which may be positioned outside of the lower frequency band arms and may be of unequal length to assist in creating a omnidirectional antenna pattern in the azimuth plane. The lower frequency band arms may be of substantially equal length.

The lengths of the high frequency band arms of the first dual band element 101 may be mirrored in the second dual band element 103 with respect to the longitudinal axis of the printed circuit board PCB 102.

FIG. 4 additionally illustrates a feed terminal 109 which may be approximately equidistant from the first dual band element 101 and the second dual band element 103 and which may be positioned on the PCB 102. The feed terminal 109 may connect a feed coaxial cable 111 which may connect to the signal source for the antenna to a transmission line 113 and may extend to the first dual band element 101 and to the second dual band element 103 and which may be a 100 ohm microstrip transmission line. The center conductor of the coaxial cable 111 may connect to the dual band elements 101, 103 while the outer conductor of the coaxial cable 111 may connect to the ground of the printed circuit board 102. Each of the transmission lines 113 may terminate in an impedance transformer 115 which may connect to the first dual band element 101 and the second dual band element 103 to supply the signal from the signal source to the respective elements 101, 103. The impedance transformer 115 may be a tapered, wideband, impedance transformer.

FIG. 6 illustrates a top view of the antenna array which may include 4 antennas positioned approximately 90° from each other and illustrates the antenna 100 and the coaxial cable 111.

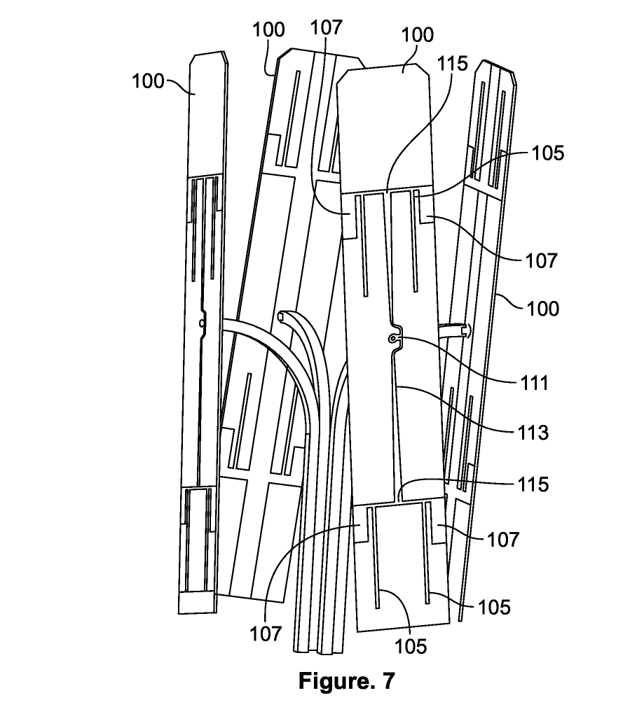

FIG. 5 illustrates a bottom view of the antenna array which may include 4 antennas positioned approximately 90° from each other and illustrates the antenna 100 and the coaxial cable 111.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) An antenna array for receiving and transmitting signals, comprising:
a printed circuit board;
a first dual frequency band element for transmitting and receiving the signals being mounted on a first end of the printed circuit board;
a second dual frequency band element for transmitting and receiving the signals being mounted on a second end of the printed circuit board; and
wherein the antenna array includes a first antenna and the first antenna is angled at a first angle with respect to the horizontal plane.

2) An antenna array for receiving and transmitting signals as in claim 1, wherein the antenna array includes a second antenna angled at a second angle beta.

3) An antenna array for receiving and transmitting signals as in claim 1, wherein the first dual frequency band element includes a first low frequency band element and a pair of first high frequency band element and wherein the first low frequency band element is between the pair of first high frequency band elements;

4) An antenna array for receiving and transmitting signals as in claim 1, wherein the second dual frequency band element includes a second low frequency band element and a pair of second high frequency band elements and wherein the second low frequency band element is between the pair of second high frequency band elements.

5) An antenna array for receiving and transmitting signals as in claim 1, wherein the first dual band elements includes a pair of first band element, each first band element being positioned longitudinally adjacent to the other first band element.

6) An antenna for receiving and transmitting signals as in claim 1, wherein the second dual band elements includes a pair of second band element, each second band dipole being positioned longitudinally adjacent to the other second band element.
